(19) United States
(12) Patent Application Publication
(10) Pub. No.: US 2025/0315516 A1
(43) Pub. Date: Oct. 9, 2025

(54) HARD FENCING CODE

(71) Applicant: International Business Machines Corporation, Armonk, NY (US)

(72) Inventors: Tabor R. POWELSON, Poughkeepsie, NY (US); Krunal SHAH, Fishkill, NY (US); Edward PRYOR, Poughkeepsie, NY (US); Andrew C. M. HICKS, Highland, NY (US); Ryan Thomas RAWLINS, New Paltz, NY (US)

(21) Appl. No.: 18/627,986

(22) Filed: Apr. 5, 2024

(51) Int. Cl. G06F 21/54; G06F 21/57

(52) U.S. Cl. CPC G06F 21/54; G06F 21/577; G06F 2221/033

(57) ABSTRACT

Embodiments herein describe techniques for preventing execution of instructions of disabled program objects using computer software tools, to enhance computing systems from malicious attacks. Disclosed methods, systems, and computer program products enable hard fencing program objects in a program code, automatically blocking disabled code paths and preventing execution of program instructions within fenced code areas, and re-enabling the program objects, enabling execution of the program instructions within unfenced code areas. In a disclosed embodiment, a system applies hard fencing code to fence the identified code areas, where hardware cannot execute code within the fenced code areas. One fencing method uses a code removal fencing method, such as encrypting code, or overwriting code, within the fenced code areas. Another fencing method uses a processor hardware based function that sets a non-executable state for the fenced code areas, such as Instruction Execution Protection (IEP).

### BACKGROUND

The present invention relates to the data processing field, and more specifically, to disabling blocking program objects and preventing execution of disabled program objects in a program code.

When program code is shipped, some software paths or object code are disabled for one of several business reasons. There still exists the potential for a malicious actor or accidental branching to the disabled object code. This presents a risk of having potentially outdated or not well tested object code on a system that could be exploited. New techniques are needed for effectively and efficiently disabling, blocking, and preventing execution of program objects in a program code, and re-enabling the disabled code and enabling execution of the program objects and instructions for possible future use.

### SUMMARY

Embodiments of the present disclosure are directed to methods, systems, and computer program products for implementing hard fencing code for disabling and blocking program objects in a program code, and preventing execution of program instructions within disabled program objects in the program code.

According to one embodiment of the present disclosure, a non-limiting computer implemented method is provided. The method comprises obtaining an input request to fence one or more program objects in a program code, where the program objects are disabled; identifying, based on the input request, code areas of the one or more disabled program objects that should be fenced off; and inserting hard fencing code for fencing the code areas to generate fenced code areas, where hardware cannot execute code within the fenced code areas.

Other disclosed embodiments include a computer system and computer program product for implementing hard fencing code for disabling, blocking, and preventing execution of program objects in a program code, implementing features of the above-disclosed method.

### BRIEF DESCRIPTION OF THE DRAWINGS

FIG. 1 is a block diagram of an example computer environment for use in conjunction with one or more disclosed embodiments;

FIG. 2 is a schematic and block diagram of an example system for implementing hard fencing code for blocking disabled object code in a program code according to one or more disclosed embodiments;

FIG. 3 is a flowchart of an example operations of a method for implementing hard fencing code for blocking disabled object code in a program code according to one or more disclosed embodiments;

FIG. 4 is a flowchart illustrating example operations of a method for identifying and performing hard fencing code for blocking disabled object code in a program code according to one or more disclosed embodiments;

FIG. 5 is a flowchart illustrating example operations of a method for disabling hard fencing code for unblocking disabled object code in a program code according to one or more disclosed embodiments;

FIG. 6 is a diagram illustrating example details of a Functional Registry Mechanism of the system of FIG. 2 according to one or more disclosed embodiments;

FIG. 7 is a diagram illustrating example details of a Code Path Mapping Table of the system of FIG. 2 according to one or more disclosed embodiments;

FIG. 8 is a diagram illustrating example details of a Fence Code Table of the system of FIG. 2 according to one or more disclosed embodiments;

FIG. 9 is a flowchart illustrating example operations of a method for creating a Code Path Mapping Table according to one or more disclosed embodiments;

FIGS. 10A, and 10B together provide a flowchart illustrating example operations of a method for implementing a Fence Code Table of the system of FIG. 2 according to one or more disclosed embodiments;

FIG. 11 is a flowchart of an example operations of a method for identifying a preferred type of hard fencing of disabled object code in a program code according to one or more disclosed embodiments;

FIG. 12 is a flowchart of an example operations of a method for implementing hard fencing using encryption according to one or more disclosed embodiments;

FIG. 13 is a flowchart of an example operations of a method for implementing hard fencing using Instruction Execution Protection (IEP) according to one or more disclosed embodiments; and

FIG. 14 is a flowchart illustrating a method for hard fencing code of disabled object code in a program code of a disclosed embodiment.

### DETAILED DESCRIPTION

Embodiments herein describe techniques for disabling, blocking, and preventing execution of program objects in a program code using computer software tools. Embodiments of the present disclosure provide methods, systems, and computer program products for implementing hard fencing for disabling and blocking program objects in a program code to prevent execution of instructions of the disabled program objects, and for re-enabling the disabled program objects in the program code to allow execution of instructions of the program objects. In a disclosed embodiment, hard fencing code is inserted to code areas of disabled program objects to prevent hardware from executing code within fenced code areas. In an embodiment, the fenced code areas are fenced using encryption, loading an internal encryption key, and encrypting code within the code areas using the encryption key. By fencing the code areas using encryption, the instructions are unrecognizable by the processor and cannot be physically executed. In one embodiment, the fenced code areas are fenced using a processor hardware based function that sets an un-executable state for the fenced code areas, such as that performs Instruction Execution Protection (IEP), allocating the identified code areas to a non-executable state, with instructions within the code areas set as non-executable to prevent execution of any instructions from the fenced code areas. In one embodiment, the fenced code areas can be unfenced, re-enabling the disabled program objects of the program code such that instructions can begin execution again. Embodiments of the present disclosure enable automatically blocking disabled code paths using hard fencing code, where hardware cannot execute code within the fenced code areas, which enhances system security against malicious actors.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

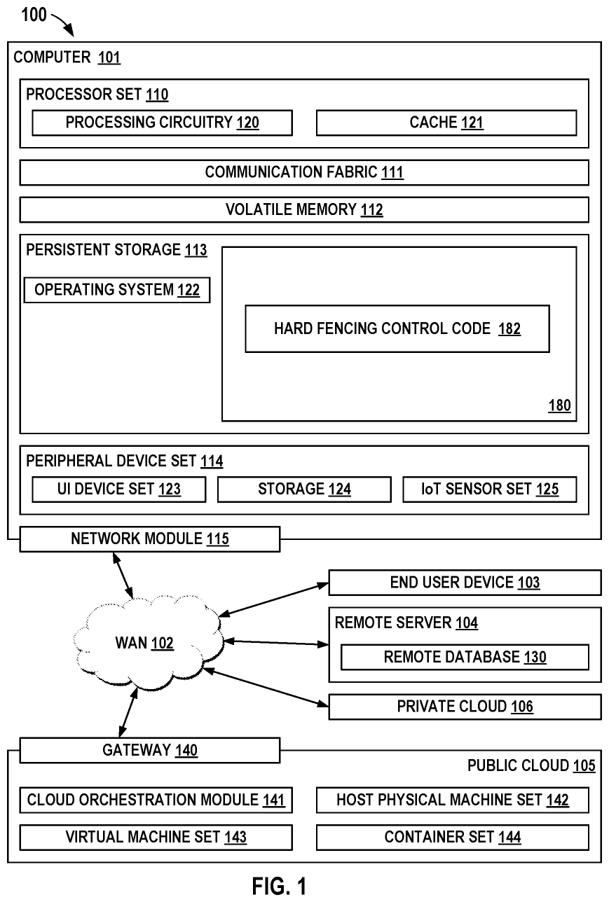

Referring to FIG. 1, a computing environment 100 contains an example of an environment for the execution of at least some of the computer code involved in performing the inventive methods, such as a Hard Fencing Control Code 182, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

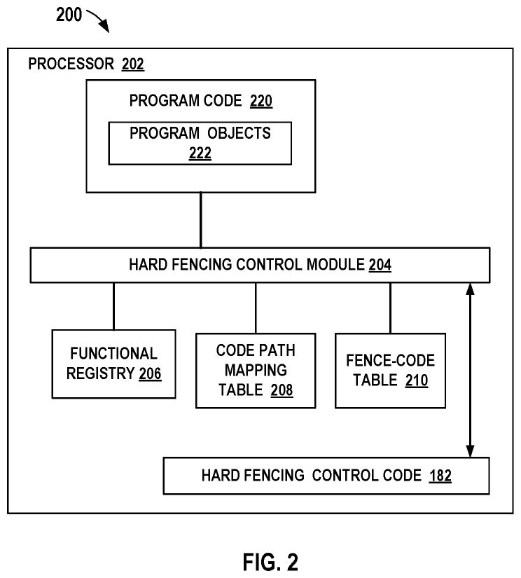

FIG. 2 illustrates an example system 200 for implementing hard code fencing of disabled program objects in a program code according to one or more disclosed embodiments. System 200 can be used in conjunction with the computer 101 and cloud environment of the computing environment 100 of FIG. 1 with the Hard Fencing Control Code 182 for implementing methods according to one or more embodiments.

System 200 performs enhanced methods for implementing hard fenced code and automatically blocking disabled code paths of disclosed embodiments. System 200 includes program code 220 of a system including disabled program objects 222 to be fenced in accordance with disclosed embodiments. System 200 identifies code areas of at least one disabled code path of the one or more disabled program objects 222; and applies hard fencing code for fencing the identified code areas. In a disclosed embodiment, the hard fencing code prevents execution of program instructions within the fenced code areas, enhancing protection and system security against malicious attacks.

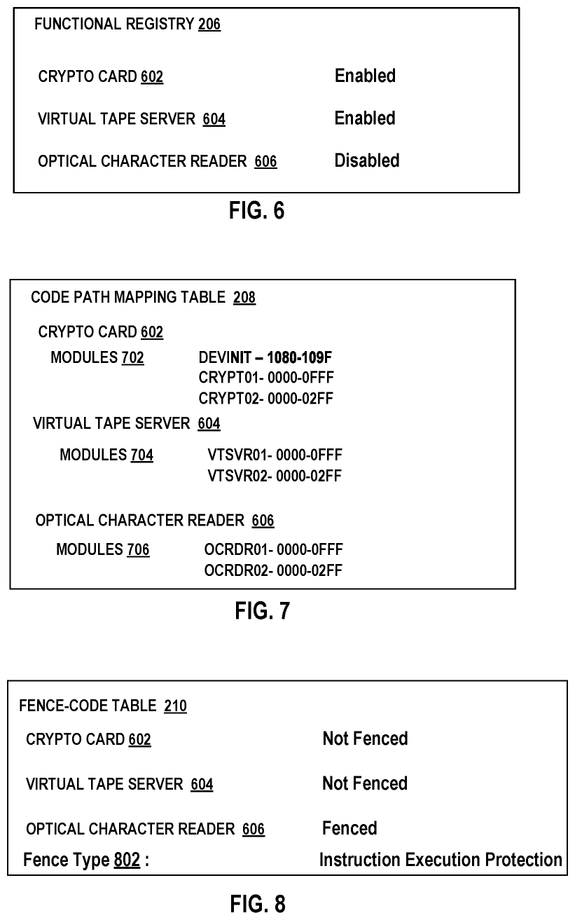

System 200 includes a processor 202, a Hard Fencing Control Module 204 used with the Hard Fencing Control Code 182 to control operations of disclosed methods for implementing hard code fencing of disabled program objects of disclosed embodiments. In a disclosed embodiment, system 200 includes a Functional Registry 206, a Code Path Mapping Table 208, and a Fence-Code Table 210 used together with the Hard Fencing Control Module 204 to perform operations of hard code fencing methods. An example Functional Registry 206 is illustrated in FIG. 6, an example Code Path Mapping Table 208 is illustrated in FIG. 7, and an example Fence-Code Table 210 is illustrated in FIG. 8.

In FIG. 6, a Functional Registry 206 includes example system functions with an enabled or disabled status. In a disclosed embodiment, the Functional Registry 206 keeps track of the system functions that are currently enabled, or not enabled, and individual functions can register with the Functional Registry 206 to indicate whether they are enabled or disabled. In an example embodiment, the Functional Registry 206 registers whether attached hardware devices are installed, such as a Peripheral Component Interconnect Express (PCIe) attached Crypto Card 602, a Virtual Tape Server 604, or an Optical Tape Reader 608. As shown in FIG. 6, the Functional Registry 206 includes enabled or disabled status of system functions or hardware devices, such as the Crypto Card 602 and the Virtual Tape Server 604 are enabled, and the Optical Tape Reader 608 is disabled.

In an example embodiment, a code developer can tag certain code modules or sections of modules as being related to certain functions. For example as illustrated in the following Table 1, which provides a source code excerpt for an example module DEVINIT, using macro invocations “START_FUNCTION” and “END_FUNCTION”, for specifying the function involved. The example code block below shows general processing, which is not specific to any function, followed by a block of code to initialize crypto cards (lines 3-5). Because lines 3-5 are specific to crypto cards, the developer can code the START_FUNCTION on line 2, and END_FUNCTION on line 6.

### Table 1

1 Call PerformGeneralProcessing( );
2 ?START_FUNCTION(function:=‘CryptoCard’);
3 DO I=1 TO CardCount;
4 Call InitializeCryptoCard(I);
5 End;
6 ?END_FUNCTION(function:=‘CryptoCard’);

In FIG. 7, the example Code Path Mapping Table 208 includes Crypto Card 602, the Virtual Tape Server 604 and the Optical Tape Reader 608 as illustrated of FIG. 6, each shown with respective example modules 702, 704, 706, or sections of modules, as being related to functions of the Functional Registry 206 is illustrated in FIG. 6. When the source code is compiled and the function tags are included, a new dataset for the Code PathMapping Table 208 is created that maps the modules and the affected object code ranges, designated by offsets into the module. As shown in the example Code PathMapping Table 208 and in the above example Table 1, for a device initialization module DEVINIT, the offsets into the object code (e.g. 1080-109F) are saved in the Code PathMapping Table for the DEVINIT location.

In FIG. 8, the example Fence-Code Table 210 includes Crypto Card 602, the Virtual Tape Server 604 and the Optical Tape Reader 608 as illustrated of FIGS. 6, and 7, each shown with a fencing status of fenced or not fenced and an optional selected fence type 802, shown as IEP. At initial program load (IPL), system 200 builds the Fence-Code Table 208 based on the Functional Registry 206, such as illustrated in FIG. 6, and the Code Path Mapping Table 208, such as illustrated in FIG. 7 The Fence-Code Table 210 (one example being shown in FIG. 8) keeps track of the functions and whether or not they are currently fenced, and if fenced, the selected method type 802 of being fenced (e.g., using Instruction Execution Protection, Encryption, Overwriting or other suitable fencing methods).

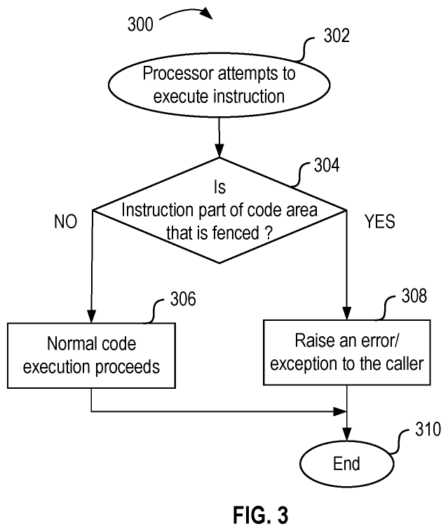

FIG. 3 is a flowchart of an example operations of a method 300 for implementing hard fencing code of disabled object code in a program code according to one or more disclosed embodiments. Method 300 can be implemented by system 200 in conjunction with computer 101 of FIG. 1 with the Hard Fencing Control Code 182 of disclosed embodiments. The same reference numbers as used in FIG. 2, are used for identical or similar components in FIGS. 3, 4, 5, 6, 7, 8, 9, 10A, 10B, 11, 12, 13, and 14. Method 300 illustrates example operations enabled by implemented hard fenced code of disclosed embodiments.

At block 302, a system processor, such as processor 202 attempts to execute an instruction of complied program code. As shown at decision block 304, checking is performed to determine whether the instruction is part of a code area that is fenced. When determined the instruction is not part of a fenced code area, normal code execution proceeds at block 306. At block 308, an error or exception to the caller is raised when determined the instruction is part of a fenced code area, and operations end at block 310. Preventing execution of the fenced code of disclosed embodiments advantageously enables enhanced security against malicious actors bypassing disabled code paths.

In an embodiment, with the fenced code areas preventing instruction execution at a hardware level, for example, it is not possible for the processor attempting to execute an instruction that is part of a fenced code area because the instructions are unrecognizable to the processor and cannot physically be executed. For example, the disabled object code that is part of a fenced code area can be encrypted or otherwise blocked as non-executable. When the processor attempts to execute the instruction or fenced code it results in error or exception depending on the fencing mechanism. For example, the exception, such as an abnormal end (abend) code 0C1 for invalid opcode, may occur when the fenced code is encrypted, or an abend code 0C4-4 may occur when the fenced code is marked as protected via Instruction Execution Protection (IEP). Another fencing technique is a code removal fencing method to overwrite code of code areas to be fenced, such as overwriting code with binary zeros (0s), where hardware cannot execute within fenced areas that are overwritten, resulting in an exception when the processor attempts to execute the instruction or fenced code. The overwriting code removal method is more permanent, and not as easily reversable. In a disclosed embodiment, to undo or unfence the code areas, the overwritten code can be restored from either a remote or local backup, or have PTFs (Program Temporary Fix) containing the code later be re-applied.

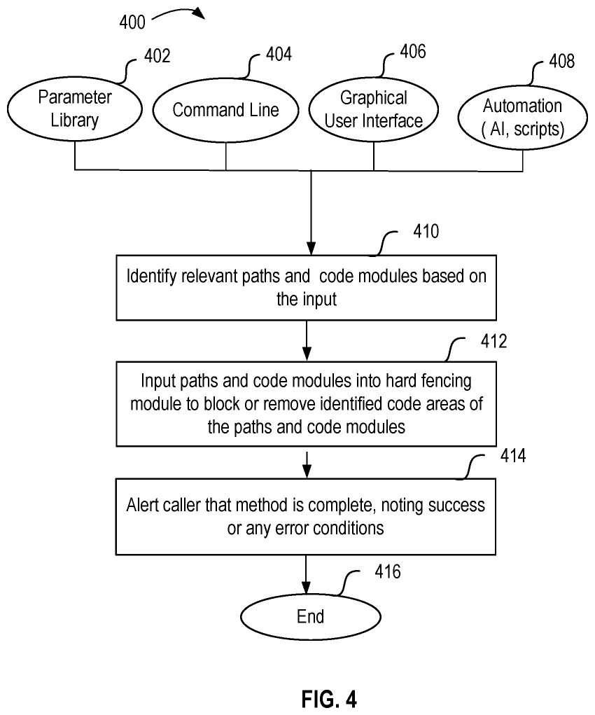

FIG. 4 illustrates example operations of a method 400 for identifying and performing hard fencing code for disabling object code in a program code according to one or more disclosed embodiments. Method 400 can be implemented by system 200 in conjunction with computer 101 of FIG. 1 with the Hard Fencing Control Code 182 of disclosed embodiments.

At block 402, system 200 receives an input request to fence one or more program objects in a program code, where the input request is from a parameter library, such as a SYS1.PARMLIB(HARDFNCE) member. At block 404, system 200 receives an input request to fence one or more program objects in a program code, where input request is from command line, for example from a command HARDFNCE. At block 406, system 200 receives an input request to fence one or more program objects in a program code, where input request is from a Graphical User Interface (GUI). At block 408, system 200 receives an input request to fence one or more program objects in a program code, where input request is from an automation function, such as an Artificial Intelligence (AI) function, scripts, system interrupts, and the like.

To protect against code modules that should be fenced but are not yet loaded into memory, at program fetch time, the system 200 cross references the Fence-Code Table 210 combined with the Code Path Mapping Table 208, to prevent the loading of any fenced code into memory. This prevents a program from loading and executing any code that is fenced that was not yet loaded when the fence was originally requested. As an optional optimization, program vector tables can be updated at fence time in order to directly mark the affected code as being fenced, and that designation can be used to know whether it should prevent the program fetch without having to cross reference the tables at load time.

At block 410, system 200 identifies relevant paths and code modules, or sections of code modules, based on a given received input request. At block 412, system 200 applies or inputs the involved paths and code modules to a hard fencing module, such as the Hard Fencing Control Module 204, which blocks or removes the identified code areas. At block 414, system 200 alerts the caller that the method is complete, includes any success or error conditions with the completion alert. In disclosed embodiment, the hard fencing module inserts hard fencing code for fencing the code areas to generate fenced code areas, for example, using a code removal fencing method, such as an encryption fencing method, or an overwriting fencing method, or using a processor hardware based function, such as Instruction Execution Protection (IEP).

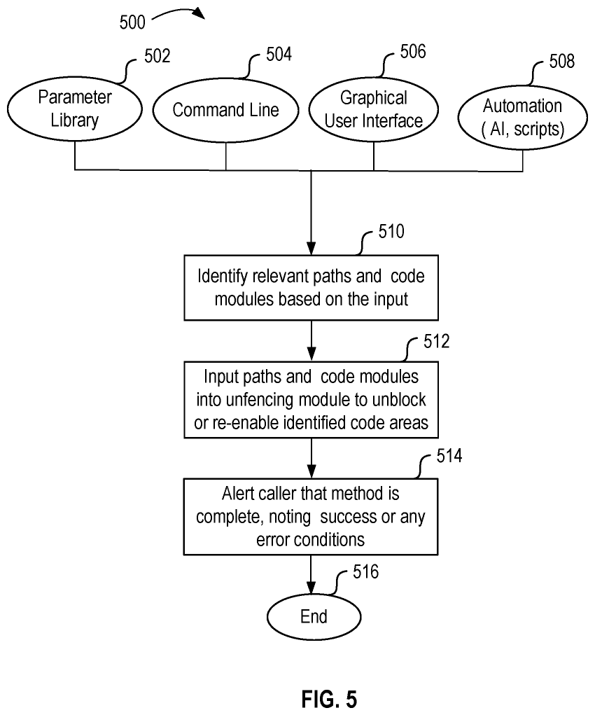

FIG. 5 illustrates example operations of a method 500 for disabling or unblocking fenced code areas according to one or more disclosed embodiments. Method 500 can be implemented by system 200 in conjunction with computer 101 of FIG. 1 with the Hard Fencing Control Code 182 of disclosed embodiments.

Method 500 performs operations for unblocking (i.e., releasing or undoing) the fenced code areas, which is similar to the blocking/fencing flow of method 400 in FIG. 4, except the identified code is unblocked. As shown, system 200 receives an input request to unfence one or more program objects in a program code at blocks 502, 504, 506, and 508, which includes receiving respective input requests from one of a parameter library, a command line, a Graphical User Interface (GUI), or an automation function to unblock or unfenced code areas, or add identified areas. At block 510, system 200 identifies relevant paths and code modules, or sections of code modules, based on a given received input request. At block 512, system 200 applies the involved paths and code modules to the Hard Fencing Control Module 204 for unblocking, which unblocks or re-enables the identified code areas. At block 514, system 200 alerts the caller that the method unblocking fenced code areas is complete.

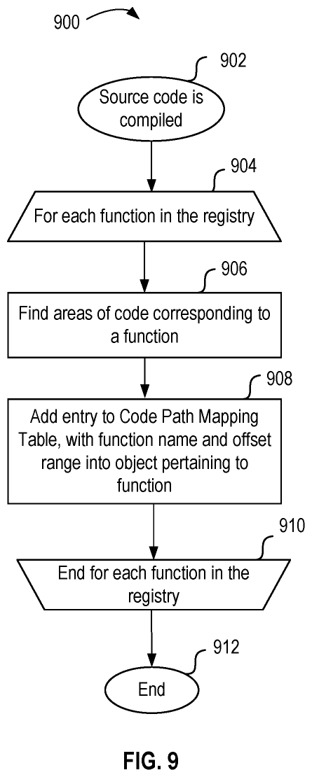

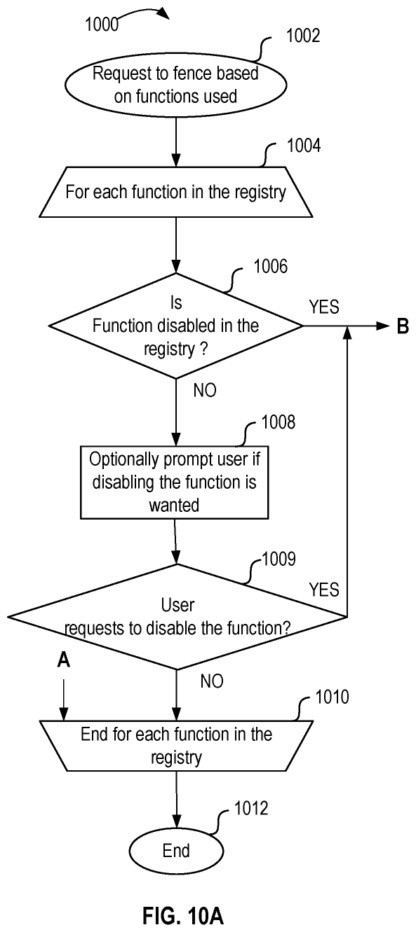

FIG. 9 illustrates example operations of a method 900 for creating a Function Mapping Table of the system 200 according to one or more disclosed embodiments. Method 900 can be implemented by system 200 in conjunction with computer 101 of FIG. 1 with the Hard Fencing Control Code 182 of disclosed embodiments.

At block 902, system 200 begins to create a Code Path Mapping Table, such as the Code Path Mapping Table 208 illustrated in FIGS. 2 and 7 when the source code is compiled, and the function tags are included in the compiled code. At block 904, for each function in the registry, such as Functional Registry 206, system 200 finds areas of code corresponding to a function. At block 906, the Code Path Mapping Table is created with system 200 adding an entry to the Code Path Mapping Table that includes a function name and offset range into the object code corresponding to the function. System 200 maps the code modules and the affected object code ranges, designated by offsets into the module, for each function at block 906, such as illustrated in the Code Path Mapping Table 208 in FIG. 7. At block 910, system 200 completes processing or ends for each function of Functional Registry 206, and operations end at block 912.

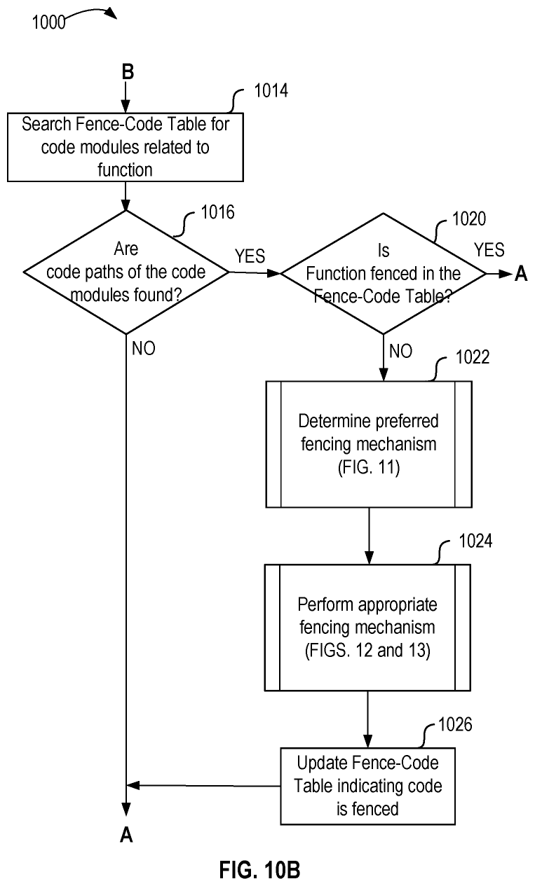

FIGS. 10A, and 10B together illustrate example operations of a method 1000 for implementing a Fence Code Table 210 illustrated in FIGS. 2 and 8 according to one or more disclosed embodiments. Method 1000 can be implemented by system 200 in conjunction with computer 101 of FIG. 1 with the Hard Fencing Control Code 182 of disclosed embodiments.

In FIG. 10A, at block 1002 receives a request to fence based on functions used, and begins to create a Fence Code Table 210. At block 1004, for each function in the Functional Registry 206, system 200 checks whether the function is disabled in the Functional Registry 206 at decision block 1006. When determined that the function is disabled in the Functional Registry 206 at decision block 1006, operations continue at block 1014 following entry point B in FIG. 10B. When the function is not disabled in the Functional Registry 206, at block 1008, system 200 optionally prompts the user to input whether disabling the function is wanted. At decision block 1009, system 200 checks whether the user request to disable the function. If true, operations continue at block 1014 following entry point B in FIG. 10B. At block 1010, system 200 completes processing or ends for each function in Functional Registry 206 and operations end at block 1012.

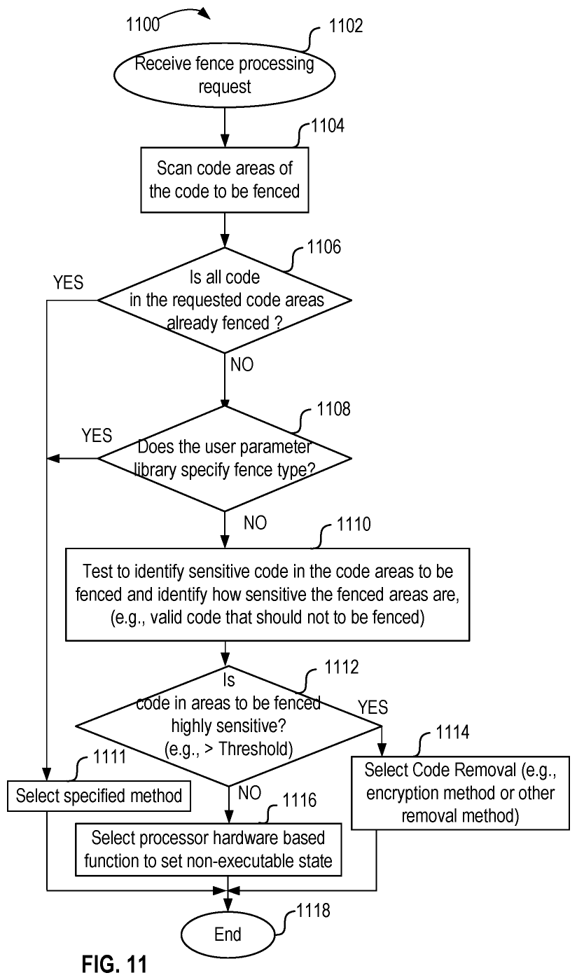

In FIG. 10B at block 1014, system 200 searches the Fence-Code Table for modules related to the function. At decision block 1016, system 200 checks whether code paths are found of the code modules related to the given disabled registered function. When code paths are found, at decision block 1020, system 200 checks whether the function is fenced in the Fence Code Table 210 (e.g. where fencing status (e.g., fenced or unfenced) for functions is stored as illustrated in FIG. 8). When the function is identified as already fenced in the Fence-Code Table 210, operations return to block 1010 following entry point A in FIG. 10A. When the given function is found, and the function is identified as unfenced (not yet fenced) in the Fence-Code Table 210, system 200 determines what fencing method is preferred (as illustrated in FIG. 11), at block 1022.

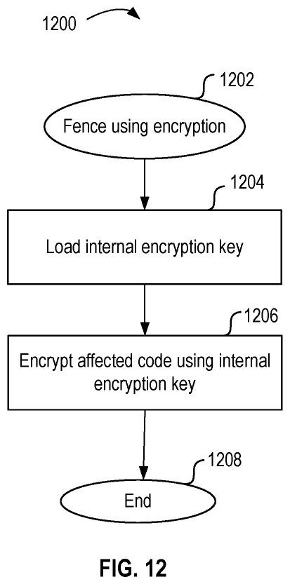

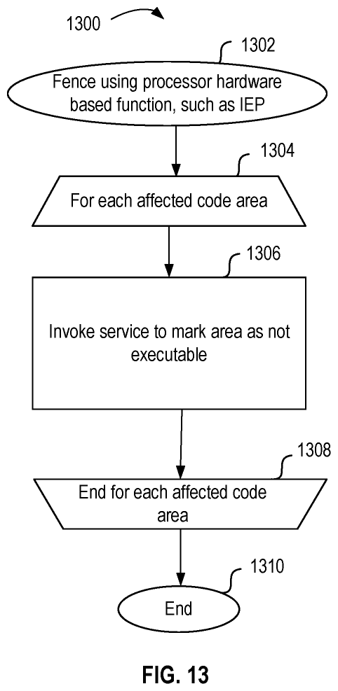

In FIG. 10B at block 1024, system 200 performs fencing of code areas of the one or more disabled program objects using the selected fencing method. When the fencing is successfully completed, at block 1026, system 200 updates the Fence-Code Table 210 with the preferred fencing mechanism 802. Fencing operations with the selected or preferred fencing mechanism 802, such as for an encryption method 1200 are illustrated in FIG. 12, and an IEP method 1300 are illustrated in FIG. 13.

FIG. 11 illustrates example operations of a method 1100 for identifying a preferred fencing type or fencing method according to one or more disclosed embodiments. Method 1100 can be implemented by system 200 in conjunction with computer 101 of FIG. 1 with the Hard Fencing Control Code 182 of disclosed embodiments. At block 1102, system 200 receives a fence processing or fencing request. At block 1104, system 200 starts the determination of the preferred type or fencing method by scanning areas of code to be fenced. At decision block 1106, system checks whether the code paths in the requested code areas are already fenced. When the code paths in the requested code areas are already fenced, the process is completed at block 1118. When the code paths in the requested code areas are not already fenced, at block 1108, system checks whether a user parameter library (Parmlib) member specified a fencing method. If a fencing method is specified, system 200 selects that user specified fencing method at block 1111. If a fencing method is not specified, at block 1110, system 200 tests (e.g., uses a lookaside table or other method) to identify sensitive code in the areas to be fenced, and identify how sensitive the fenced area are. At decision block 1112, system checks whether the areas to be fenced are highly sensitive, (e.g., highly sensitive or above a set threshold level) which could include whether the code has a high risk of being exploited. When determined that the areas to be fenced code to be fenced are sensitive code (e.g., highly sensitive), at block 1114, system 200 chooses to remove the code to be fenced, which may incur a higher CPU cost to perform the code removal, than other fencing methods. An example code removal method is illustrated in FIG. 12. Another code removal method is overwriting the code to be fenced, instead of encrypting the code as shown in FIG. 12. Otherwise, when determined that the code to be fenced is not highly sensitive, at block 1116, system 200 can utilize another default technique of protecting execution, such as an architected mechanism for preventing instruction execution, or a processor hardware based function that sets a non-executable state for the fenced code areas, which may incur less of a CPU cost than removing the code. In one embodiment, at block 1116, system can use the processor hardware based function that sets a non-executable state for the fenced code areas, such as that performs Instruction Execution Protection (IEP), as illustrated in FIG. 12, which may incur less of a CPU cost than removing the code.

FIG. 12 illustrates example operations of a method 1200 to implement fencing using encryption according to one or more disclosed embodiments. Method 1200 can be implemented by system 200 in conjunction with computer 101 of FIG. 1 with the Hard Fencing Control Code 182 of disclosed embodiments. At block 1202, system 200 obtains a request to fence using encryption in accordance with disclosed embodiments. As described above, system 200 can uses encryption as a code removal method of fencing when the identified code areas to be fenced includes sensitive code, for example highly sensitive code or code having a high risk of being exploited, and/or identifying valid code in, a memory block within a memory area to be fenced, where the valid code should not be fenced. It is undesirable to invoke IEP on a page that would affect other valid code, since it would make that valid code now be fenced.

At block 1204 system 200 loads an internal encryption key to use for encrypting the code needed to be fenced, without impacting or changing valid code within the identified code areas of the disabled memory paths. In certain computer architectures, encrypting the code enables improved granularity, (e.g., system 200 can encrypt to the exact byte of identified specific code of identified code areas to be fenced, as opposed to using the IEP function, which allocates an entire memory block or page to a non-executable state, such as a memory block or page in one example is 4 kilobytes (KB) in length). At block 1206, system 200 encrypts the identified code objects to be fenced using the encryption key. Encrypting the disabled code paths of identified code objects prevents the processor from recognizing instructions within the fenced code areas. The encrypting fencing operations end at block 1208.

FIG. 13 illustrates example operations of a method 1300 for implementing fencing using a processor hardware based function, such as IEP according to one or more disclosed embodiments. Method 1300 can be implemented by system 200 in conjunction with computer 101 of FIG. 1 with the Hard Fencing Control Code 182 of disclosed embodiments. At block 1302, system 200 obtains a request to fence using a processor hardware based function, for example IEP fencing in accordance with disclosed embodiments. At block 1304, for each affected code area, system 200 invokes service to mark code area as not executable. At block 1306, system 200 ends for each affected code area, and operations end at block 1310. As described above, in one example, system 200 uses IEP fencing, which is faster than using encryption as the method of fencing, since IEP fencing marks or allocates the involved storage areas as not executable, or to a non-executable state. Using encryption to fence the code is significantly more costly for CPU use, requiring multiple iterations through the area of storage and applying encryption algorithms, which may consume a considerable amount of CPU time. There are other examples of benefits of using IEP over encryption, overwriting code, or other code removal methods, for example IEP still allows read data access.

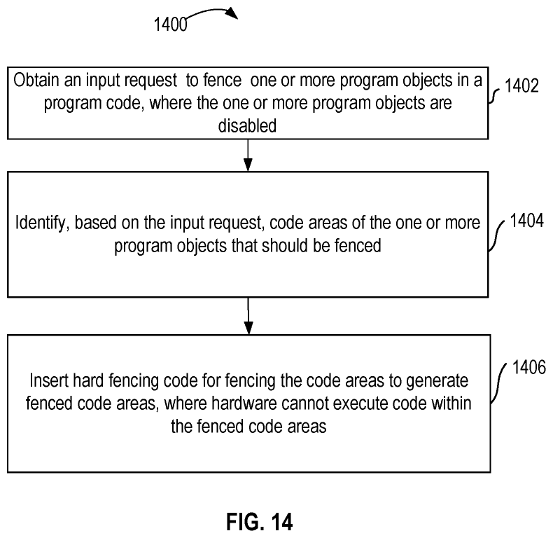

FIG. 14 is a flowchart illustrating a method 1400 for implementing hard fencing code to block disabled programs objects in a program code of a disclosed embodiment. Method 1400 can be implemented by system 200 in conjunction computer 101 of FIG. 1 with the Hard Fencing Control Code 182 of disclosed embodiments. Method 1400 includes operations and features of the methods 300, 400, 500, 900, 1000, 1100, 1200, and 1300 of FIGS. 3, 4, 5, 9, 10A and 10B, 11, 12, and 13.

At block 1402, system 200 obtains an input request to fence one or more disabled program objects in a program code, where the one or more program objects are disabled. In a disclosed embodiment, the request to fence one or more program objects can be implemented with a user parameter library member, (e.g., a SYS1.PARMLIB(HARDFNCE) member), a command line, for example from a command HARDFNCE, a Graphical User Interface, or an Automation function, which includes, for example one of an AI module, scripts, system interrupts, and the like (e.g. as shown in FIG. 4).

At block 1404, system 200 identifies, based on the input request, code areas of the one or more disabled program objects that should be fenced off. In an embodiment, system 200 identifies the code areas to be fenced, which include paths and code modules to be fenced based on identifying registered functions and tagging object code modules related to the registered functions for the one or more disabled program objects. In an embodiment, system 200 creates a code path mapping table for each registered function, based on identifying registered functions and tagging the object code modules, including code areas of the object code modules corresponding to registered functions for the one or more program objects, and creates a fence-code table, based on the code path mapping table, comprising the code areas of the object code modules of each registered function and a status of fenced or not fenced.

At block 1406, system 200 inserts hard fencing code for fencing the code areas to generate fenced code areas, where hardware cannot execute code within the fenced code areas. In a disclosed embodiment, the disabled program objects are fenced using an identified fencing strategy, for example, using a code removal method, such as encryption as the method of fencing the disabled program objects, or using memory management to allocate the identified code areas to a non-executable state as the method of fencing. In a disclosed embodiment, using encryption as the method of fencing, system 200 loads an internal encryption key and encrypts the affected code using the encryption key. In another disclosed embodiment, using a processor hardware based function that sets an non-executable state for the fenced code areas is selected as the method of fencing, such as an IEP method of fencing for code allocation to a non-executable state, system 200 sets instructions within the code areas as non-executable to prevent any instructions from the code areas to execute. Allocating the identified code areas to a non-executable state can be implemented using an Instruction Execution Protection (IEP) function (e.g. as described above and illustrated in FIGS. 4, 6, 7, and 8). In a disclosed embodiment, another fencing technique is a code removal fencing method that overwrites code of code areas to be fenced, such as overwriting code with binary zeros (0s). The overwriting code removal method is more permanent, and not as easily reversable. In a disclosed embodiment, to undo or unfence the code areas, the overwritten code can be restored from either a remote or local backup, or have PTFs (Program Temporary Fix) containing the code later be re-applied.

While the foregoing is directed to embodiments of the present invention, other and further embodiments of the invention may be devised without departing from the basic scope thereof, and the scope thereof is determined by the claims that follow.

What is claimed is:

1. A method comprising:
obtaining an input request to fence one or more program objects in a program code, wherein the program objects are disabled;
identifying, based on the input request, code areas of the one or more disabled program objects that should be fenced off; and
inserting hard fencing code for fencing the code areas to generate fenced code areas, wherein hardware cannot execute code within the fenced code areas.

2. The method of claim 1, wherein obtaining the input request further comprises receiving the input request from one of a parameter library, a command line, a Graphical User Interface (GUI), an automation function, or system interrupt.

3. The method of claim 1, wherein identifying, based on the input request, the code areas to be fenced of the one or more disabled program objects further comprises identifying registered functions and tagging code modules related to the registered functions for the one or more disabled program objects.

4. The method of claim 3, further comprises creating a code path mapping table for each registered function, based on identifying registered functions and tagging the object code modules, comprising code areas of code modules corresponding to registered functions for the one or more program objects.

5. The method of claim 4, further comprises creating a fence-code table, based on the function mapping table, comprising the code areas of the code modules of each registered function and a status of fenced or not fenced.

6. The method of claim 5, wherein inserting hard fencing code for fencing the code areas to provide fenced code areas further comprises applying hard fencing code to the code areas of the code modules of each disabled registered function that is not fenced.

7. The method of claim 1, wherein inserting hard fencing code for fencing the code areas further comprises testing the code areas of the one or more program objects to identify sensitive code in the code areas to be fenced; and identifying a fencing method based on identifying sensitive code in the code areas to be fenced.

8. The method of claim 7, wherein identifying the fencing method further comprises identifying a code removal fencing method, based on identifying sensitive code in the code areas to be fenced; wherein the code removal fencing method comprises one of using encryption fencing method for encrypting the code in the code areas, or using an overwriting fencing method for overwriting the code in the code areas.

9. The method of claim 7, wherein identifying the fencing method further comprises identifying, based on not identifying sensitive code in the code areas to be fenced, a fencing method using a processor hardware based function that sets a non-executable state for the fenced code areas, where the processor hardware based function comprises using Instruction Execution Protection (IEP).

10. The method of claim 1, further comprises receiving an input request to unfence one or more program objects in the program code; and applying hard fencing code to unfence the fenced code areas, enabling execution of program instructions within the unfenced code areas.

11. A system, one or more computer processors; and a memory containing a program which when executed by the one or more computer processors performs an operation, the operation comprising:
obtaining an input request to fence one or more program objects in a program code, wherein the program objects are disabled;
identifying, based on the input request, code areas of the one or more disabled program objects that should be fenced off; and
inserting hard fencing code for fencing the code areas to generate fenced code areas, wherein hardware cannot execute code within the fenced code areas.

12. The system of claim 11, wherein obtaining the input request further comprises receiving the input request from one of a parameter library, a command line, a Graphical User Interface (GUI), or an automation function.

13. The system of claim 11, wherein inserting hard fencing code for fencing the code areas further comprises testing the code areas of the one or more program objects to identify sensitive code in the code areas to be fenced; and identifying a fencing method based on identifying sensitive code in the code areas to be fenced.

14. The system of claim 13, wherein identifying the fencing method further comprises identifying a code removal fencing method, based on identifying sensitive code in the code areas to be fenced; wherein the code removal fencing method comprises one of using encryption fencing method for encrypting the code in the code areas, or using an overwriting fencing method for overwriting the code in the code areas.

15. The system of claim 13, wherein identifying the fencing method further comprises identifying, based on not identifying sensitive code in the code areas to be fenced, a fencing method using a processor hardware based function that sets a non-executable state for the fenced code areas, where the processor hardware based function comprises using Instruction Execution Protection (IEP).

16. A computer program product comprising a computer-readable storage medium having computer-readable program code embodied therewith, the computer-readable program code executable by one or more computer processors to perform an operation comprising:
obtaining an input request to fence one or more program objects in a program code, wherein the program objects are disabled;
identifying, based on the input request, code areas of the one or more disabled program objects that should be fenced off; and
inserting hard fencing code for fencing the code areas to generate fenced code areas, wherein hardware cannot execute code within the fenced code areas.

17. The computer program product of claim 16, wherein obtaining the input request further comprises receiving the input request from one of a parameter library, a command line, a Graphical User Interface (GUI), or an automation function.

18. The computer program product of claim 16, wherein inserting hard fencing code for fencing the code areas further comprises testing the code areas of the one or more program objects to identify sensitive code in the code areas to be fenced; and identifying a fencing method based on identifying sensitive code in the code areas to be fenced.

19. The computer program product of claim 18, wherein identifying the fencing method further comprises identifying a code removal fencing method, based on identifying sensitive code in the code areas to be fenced; wherein the code removal fencing method comprises one of using encryption fencing method for encrypting the code in the code areas, or using an overwriting fencing method for overwriting the code in the code areas.

20. The computer program product of claim 18, wherein identifying the fencing method further comprises identifying, based on not identifying sensitive code in the code areas to be fenced, a fencing method using a processor hardware based function that sets a non-executable state for the fenced code areas, where the processor hardware based function comprises using Instruction Execution Protection (IEP).
